(19) United States
(12) Patent Application Publication
(10) Pub. No.: US 2021/0097515 A1
(43) Pub. Date: Apr. 1, 2021

(54) SYSTEMS AND METHODS OF FACILITATING TRANSACTIONS ORIGINATING FROM PATRON-CONTROLLED DEVICES

(71) Applicant: Table Needs Inc., Riverside, CA (US)

(72) Inventors: Timothy Michael Jenkins, Riverside, CA (US); Daniel Joseph Cleary, Riverside, CA (US); Christopher Brian Konopasek, Valley Village, CA (US)

(21) Appl. No.: 16/588,865

(22) Filed: Sep. 30, 2019

(51) Int. Cl. G06Q 20/20; G06K 7/14

(52) U.S. Cl. CPC G06Q 20/20; G06K 7/1413; G06K 7/1417

(57) ABSTRACT

Systems and methods directed to facilitating client to business interactions and transactions are described in this application. Some embodiments include a platform server, a code-presenting apparatus, a point of sale system, an associate device, and a patron-controlled device. When, for example, a patron sits down in a restaurant, they will be able to scan a code from the code presenting device. Once the code is scanned, that patron's device will be able to place orders that the restaurant can fulfill, thereby eliminating a need for dedicated hardware that can quickly become a health hazard if not properly cleaned. In some embodiments, it is contemplated that the associate device can be omitted from the system, and it is further contemplated that, in embodiments with an associate device (e.g., a mobile device that a server can use to take orders), the associate device can double as the code-presenting apparatus.

### FIELD OF THE INVENTION

The field of the invention is systems and methods of facilitating client to business transactions within a variety of different establishment types.

### BACKGROUND

The background description includes information that may be useful in understanding the present invention. It is not an admission that any of the information provided in this application is prior art or relevant to the presently claimed invention, or that any publication specifically or implicitly referenced is prior art.

More and more establishment—especially restaurants—are working to incorporate modern technology to improve customer experiences and to facilitate customer-to-business transactions. One way the customer experience has been improved is to allow for ordering without requiring a server to be present. This can be done by, for example, including a tablet with every table, which can accept orders and transmit them to a restaurant's ordering system. When orders are placed via tablet, the restaurant's point of sale system can automatically know which table the order originated from, add the order to the table's bill, and fulfill the order (e.g., by printing a ticket to a kitchen or bar).

Others have developed different systems. For example, U.S. Pat. No. 9,117,231 to Rodgers et al. teaches a system whereby restaurant patrons can scan a QR code at a table to place orders using their personal mobile devices, obviating the need for dedicated hardware at every table. But even this idea leaves room for improvement, especially as it relates to ensuring codes generated for each table are not accessible by nefarious third parties (or parties that have already left a table). Moreover, Rodgers et al. is directed to a specific implementation of this concept, leaving open the door for many alternative system configurations that include a variety of previously undisclosed features that bring about, e.g., improved security and ease-of-use. Rodgers et al. also fails to contemplate alternative ways to present or otherwise deliver a code to patrons in an establishment, which opens the door for many security improvements.

This and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

It has yet to be appreciated that systems that allow users to make transaction requests using their own devices can be made safer, more secure, and easier to use.

### SUMMARY OF THE INVENTION

The present invention provides apparatuses, systems, and methods directed to facilitating order placement in various places of business where patrons can place orders directly from their own mobile computing devices.

In one aspect of the inventive subject matter, a system to facilitate transactions originating from a patron-controlled device is contemplated. The system comprises a platform server configured to generate a code, where the code is associated with a location in an establishment and where the platform server is configured to transmit the code to an associate device (e.g., a device controlled by an establishment employee). The associate device is configured to display the code to at least one patron of the establishment occupying the location, where the at least one patron can scan the code using the patron-controlled device. When the patron scans the code, they are then able to communicate with the platform server using the patron-controlled device. The platform server is thus further configured to: receive an interaction request from the patron-controlled device; send a notification of the interaction request to the associate device; create a modified interaction request based on the first interaction request; and send the modified interaction request to the point of sale system. The point of sale system is thus configured to receive the modified interaction request and to subsequently fulfill the modified interaction request.

In some embodiments, the code comprises at least one of a QR code, a barcode, and an alphanumeric code. The associate device can be a mobile computing device used by, e.g., a server to take orders in a restaurant. In some embodiments, the establishment is a restaurant and the location is a table in the restaurant. The code can be generated by the platform server upon request by the associate device or, in some embodiments, by the associate device itself. In some embodiments, the interaction request and the modified interaction request both comprise an order from the patron to be processed by the point of sale system (e.g., a purchase order for another drink, an appetizer, etc.). The modified interaction request can include the same information as the interaction request (e.g., in some embodiments, the platform server acts as a pass-through for the interaction request, while in other embodiments, the platform server modifies the request so that it is in a format compatible with the point of sale system).

In another aspect of the inventive subject matter, a system to facilitate transactions originating from a patron-controlled device is contemplated. This system, instead of using an associate device to present the code for scanning, uses a code-presenting apparatus (e.g., a small electronic device, a printed coaster, etc.) to allow a patron to scan the code. Otherwise, the system is largely like the one described above.

In another aspect of the inventive subject matter, a method of facilitating transactions originating from a patron-controlled device is contemplated. The method comprises: generating a code at a platform server, where the code is associated with a location in an establishment; transmitting the code to a code-displaying device; presenting the code to at least one patron of the establishment, where the patron occupies the location, the at least one patron scans the code using a patron-controlled device, and scanning the code allows the patron-controlled device to communicate with the platform server; receiving, at the platform server from the patron-controlled device, an interaction request; sending, from the platform server to the associate device, a notification of the interaction request; creating a modified interaction request based on the first interaction request; sending the modified interaction request to the point of sale system, where the point of sale system is configured to receive the modified interaction request and to subsequently fulfill the modified interaction request.

As above, the code can include at least one of a QR code, a barcode, and an alphanumeric code. The establishment can be a restaurant and the location can be a table in the restaurant. In some embodiments, the code is generated by the platform server upon request by the associate device. The interaction request and the modified interaction request can include the same information (e.g., they can be identical) in some embodiments (e.g., when the platform server acts as a pass-through for transaction requests between patron-controlled devices and a point of sale system), and both requests include, e.g., an order from the patron to be processed by the point of sale.

One should appreciate that the disclosed subject matter provides many advantageous technical effects including facilitating user-centric transactions for patrons of various establishments with improved privacy and security measures. This reduces costs and technological infrastructure required to improve customer experiences by allowing customers to, e.g., place orders without a server present.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a system of the inventive subject matter that incorporates a code-presenting apparatus.

FIG. 2 is a schematic of another system of the inventive subject matter that uses an associate device as a code-presenting apparatus.

FIG. 3 shows a flowchart of a method of the inventive subject matter.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities (e.g., of ingredients, properties such as concentration, reaction conditions, and so forth) used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

The inventive subject matter is directed to systems and methods that improve interactions between patrons (e.g., guests in an establishment) and associates (e.g., employees of an establishment such as servers, bartenders, etc.) in establishments. In the context of a restaurant, for example, many restaurants include at-table electronic devices that allow patrons to place orders or get the attention of their server. Embodiments of the inventive subject matter eliminate the need for dedicated table hardware by allowing patrons to use their own devices to place orders, get their server's attention, pay their bill, etc. Allowing people to use their own devices can have an impact on the spread of pathogens and bacteria that can live on a unit that is permanently coupled with a table and owned by an establishment. These types of permanently affixed units may not always be cleaned properly, and for at least this reason people overwhelmingly prefer to use their own devices whenever possible.

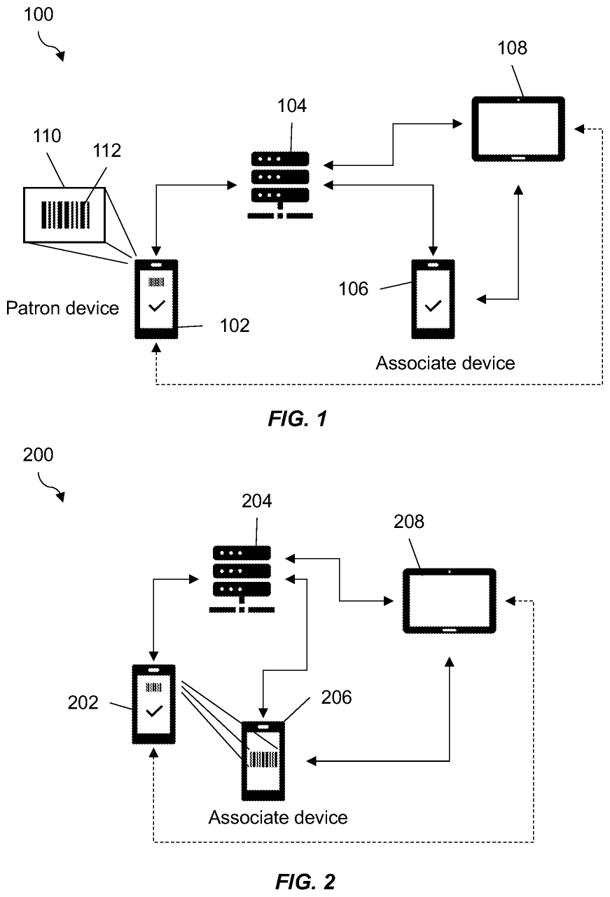

As shown in FIGS. 1 and 2, embodiments of the inventive subject matter can include a Point of Sale (POS), an associate device, and a platform server. Patron devices are supplied by patrons themselves and do not need to be incorporated into a system directly (e.g., the system is configured to interact with patron-controlled devices, but patron-controlled devices are not necessarily part of the system). Moreover, some embodiments of the inventive subject matter include just a platform server (or any other subset of devices contemplated in this application, depending on a particular application's requirements), thereby allowing establishments to retrofit, e.g., existing POS systems with the inventive subject matter to add functionality and improve the guest experience. In some embodiments, the associate device is not included, though it can be included as many restaurants now have associates using such devices (e.g., a tablet or other mobile device) to take orders.

The system 100 in FIG. 1 thus shows a system having a patron device 102, a platform server 104, an associate device 106, a POS 108, and a code-presenting apparatus 110. A patron device 102 can be any type of internet-capable mobile device (e.g., a tablet, a smartphone, a smartwatch, etc.). Patron devices of the inventive subject matter are preferably owned and controlled by patrons of an establishment in which the system 100 is set up. A code-presenting apparatus 110 can be a wide variety of different apparatuses. For example, in some embodiments, the code-presenting apparatus 110 is an electronic device capable of generating and presenting a code that can be scanned or otherwise input into a patron device 102.

The code-presenting apparatus 110 can additionally or alternatively be incorporated into existing hardware. For example, buzzers used to alert patrons when a table is available can include a code or code-presenting subsystem. For example, the buzzer can include a display that is configured to show a code. In some embodiments, the code-presenting apparatus includes a printed-on code, and when the table is ready, the code can then be linked to a table. Linking the code to a table can be accomplished in a variety of ways, which will be discussed in more detail below. In some embodiments, the code-presenting apparatus can be, e.g., a coaster, a napkin, a menu, or standalone electronic device capable of generating and presenting a code (e.g., a barcode, a QR code, an alphanumeric code, or any other type of code). It is contemplated that the code can be a one-time passcode.

In embodiments where the code-presenting apparatus is a static component (e.g., a coaster or other apparatus that does not include a display device that can present different codes), new codes can be printed as needed, and, when a code is used, an associate device or the platform server can disable the code after the bill is paid for that location.

FIG. 2 shows a system 200 of the inventive subject matter having a platform server 204, an associate device 206, and a POS 208. In this embodiment, the associate device 206 doubles as the code-presenting apparatus. Thus, the associate device 206 can present a code on its screen that, e.g., a customer with a patron device 202 can scan to gain access to the additional features described throughout this application to do things like place an order at a restaurant, etc.

The platform server 104 facilitates interactions that make systems of the inventive subject matter possible. The platform server 104 can include one or more servers (e.g., cloud servers), and the platform server 104 is configured to communicate with the patron device, the associate device 106, and the POS 108. The platform server 104 can additionally be configured to communicate with the code-presenting apparatus 110 in embodiments where the code-presenting apparatus 110 is configured to communicate over a network connection. The platform server 104 has executable software code that, upon execution, configures the platform server 104 to facilitate interactions described in this application requiring the platform server 104.

A patron device 102 can be, e.g., a mobile computing device that is controlled by a patron. It can be, for example, a smart phone that a person brings with them to a restaurant. The patron device 102 can be configured to scan a code 112 on a code-presenting apparatus 110. Executable software code can be downloaded and run on the patron device 102 to configure the patron device to be used with embodiments of the inventive subject matter. In some embodiments, users need only access a web interface upon scanning a code to enable the patron device 102 to operate with the system 100.

A point of sale (POS) system 108 (sometimes referred to as a point of purpose (POP) system) is a system that facilitates transactions between, e.g., clients and businesses such as patrons and restaurants. POS systems of the inventive subject matter should be network enabled (e.g., able to connect to the Internet or a local area network), and, in some embodiments, able to communicate (e.g., wirelessly) with associate devices of the inventive subject matter (e.g., a device controlled by a server in a restaurant that is configured to take orders).

An associate device 106 can be a mobile computing device that, e.g., waitstaff in a restaurant use to take orders and otherwise interact with a POS system. Associate devices can be, for example, smartphones, tablets, or any kind of computing device that has networking capabilities to allow it to communicate with a POS system (e.g., via direct network connection to a POS or via an internet connection). Associate devices are not necessary to implement systems of the inventive subject matter and in systems without one or more associate devices, a patron device 102 can instead communicate with a POS 108 either directly or via platform servers 104.

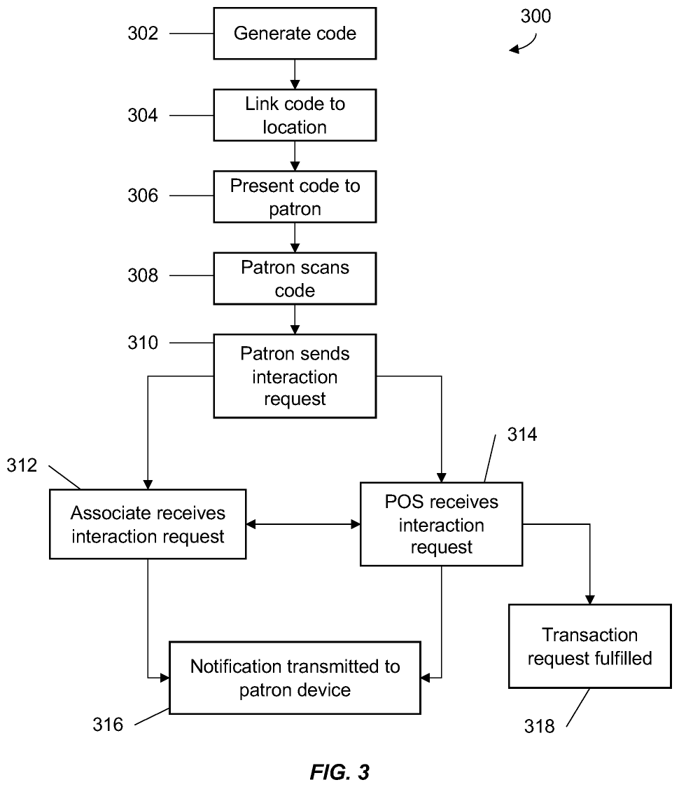

FIG. 3 is a flowchart 300 demonstrating how an embodiment of the inventive subject matter can work. First, an access code must be created as shown in strep 302. This can be accomplished by a code-presenting apparatus 110 or, in some embodiments, a code can be generated by platform servers 104 or by a POS 108 running specialize software. Each code is preferably unique, although in some embodiments, codes can be repeated after enough time has elapsed since a code was previously used (more information about duration of code validity is included below). This can help to prevent illegitimate transactions from taking place originating from a nefarious party that retains a code or is otherwise still able to access a system of the inventive subject matter even after leaving a place of business.

After a code is generated, it should be linked to a location as shown in step 304. A location in this context can be, e.g., a table, seat, or other location in a restaurant. By linking a code to a location, a patron can then use a patron device to scan that code and, e.g., place orders that are tied to that person's location within an establishment. Thus, if a person sits at a table, they can scan a code that has been linked to that table, thereby allowing them to place orders that will be associated with that table and placed on a bill for that table.

A code can be linked with a location in a variety of ways. In some embodiments, a platform server maintains a listing of pre-defined locations within an establishment. When a patron enters the establishment and takes a seat, an associate can indicate that a patron now exists at that location, prompting the platform server to generate a code that is linked to that location (e.g., the associate device prompts the platform server to generate a code according to an instruction originating from the associate). The associate in charge of that location can then ensure that the newly generated code is presented to the patron for scanning. The code can be presented by a code-presenting apparatus as described above. Thus, in some embodiments, a newly generated code can be printed on a coaster so that it can be presented to a patron while, in other embodiments, a newly generated code is electronically transmitted to an associate device or code-presenting apparatus so that a patron can scan it.

In some embodiments, some quantity of codes can be pre-generated for use throughout, e.g., a day, a week, a weekend, a month, or more. This type of system can be useful in instances where no additional electronic hardware exists for code presentation. Thus, each time a patron enters an establishment and occupies a location, an associate with the establishment can grab a pre-printed code (e.g., a code printed on a coaster), link it to the patron's location in the establishment, and then give the patron the pre-printed code for scanning. Linking a code to a location can be accomplished by, e.g., scanning that code using an associate device so that the orders placed by the patrons in that location are properly recorded and fulfilled.

In still further embodiments, an associate device can be responsible for code generation. Thus, an associate device can generate a code and then also be responsible for linking that code to a location (e.g., by communicating with the platform server). For example, an associate could greet a new table at a restaurant and then present that table with a code that the associate generated on an associate device. At any time after generating the code, the associate device can communicate with a platform server to indicate that the code is linked to a location in the restaurant. The associate's device can additionally or alternatively communicate the code and the location directly or indirectly (e.g., via the platform server) to the POS.

Thus, codes can be pre-generated or pre-printed and codes can also be generated or printed on an on-demand basis. In some embodiments, a code is linked to a location at the time it is generated, while in other embodiments, a code can be generated and then later associated with a location by, e.g., an associate working in an establishment. For example, a code can be generated on an associate device and then the associate can be prompted to indicate a location that the code should be associated with. In some embodiments, code generation can be managed by a platform server to ensure that no duplicate codes are generated, although codes that are complex enough to effectively eliminate a risk of generating two identical codes independently can be implemented (e.g., it may not be impossible to generate two identical codes, but, like shuffling a deck of cards, there can be so many possible codes that a risk of generating a duplicate is so statistically unlikely as to effectively be impossible).

In some embodiments, all newly generated codes can be set to expire after an amount of time (e.g., 30 minutes-1 hour, 1-2 hours, 2-3 hours, etc.), where the platform server manages code expirations. When a code expires, a new code can be generated upon request or automatically. Codes can also be caused to expire by an action from an associate. For example, after a table leaves, an associate can indicate the table has left, thereby causing that table's code to expire and no longer be active. In some embodiments, a code that is linked to a location can be set to expire when the bill for that location is paid.

Once a code is generated, it must be presented to a patron for scanning according to step 306. As discussed above, it can be presented on a wide variety of different code-presenting apparatuses. Because the code as presented to a patron is should already be linked to the patron's location according to step 304, when the patron uses their device to scan the code according to step 308, the action of scanning that code allows the patron's device to connect with at least the platform server (and, in some embodiments, additionally or alternatively allows the patron's device to connect to the POS or associate device over a network connection). A patron can scan a code using, e.g., a smartphone or other computing device. The patron device can complete a code scan using, e.g., a camera, an NFC chip, an RFID reader, etc.

Once a code is scanned by a patron using a patron device, the patron device can be configured to send an interaction request to either an associate device, a POS, or both (e.g., via a platform server or directly via internet connection) to carry out a variety of different functions including placing orders, asking an associate for help, paying a bill, asking for a bill, etc. Thus, according to step 310, a patron can send an interaction request using a patron device after scanning a code of the inventive subject matter.

Interaction requests can be routed in several ways. An interaction request can be transmitted to an associate device (step 312), to a POS (314), or both. These requests, in some embodiments, are routed through platform servers. When interaction requests are routed though platform servers, the platform servers can, e.g., track transaction statistics and gather other information about an establishment to help that establishment grow and understand its needs better. After receiving an interaction request, the platform server can modify the transaction request to create, e.g., a second transaction request that can then be routed to a POS or an associate device. The transaction request can be modified at least in part to ensure compatibility with the modified request's destination.

Any interaction request that is delivered to an associate device can subsequently be transmitted to a POS and vice versa. As indicated in FIGS. 1 and 2, transaction requests can be transmitted from a patron-controlled device to the platform server, an associate device, or a POS, and the request can be routed through any number of those devices before arriving at a desired destination. Ultimately any transaction request to place an order must at least result in instructions being delivered to the POS so that an order can be placed. In embodiments where a transaction request is sent to an associate device, for example, the associate controlling that device can review and modify that request before releasing the request to a POS. For example, if an order is placed and that order is sent to an associate device, the associate can review the order and make changes or collect more information from a patron before transmitting that order to the POS for fulfillment (step 318).

Whenever an interaction request is sent to an associate device, a POS, or both, receipt of that request can be acknowledged, and an acknowledgment notification can be sent to the patron's device according to step 316. Notifications can be sent to a patron device at any time throughout the process, though most typically a notification will be delivered to acknowledge that a patron's request has been received.

Thus, specific systems and methods directed to facilitating client-to-business transactions have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A system to facilitate transactions originating from a patron-controlled device, comprising:
a platform server configured to generate a code, wherein the code is associated with a location in an establishment;
wherein the platform server is configured to transmit the code to an associate device;
the associate device configured to display the code to at least one patron of the establishment occupying the location, wherein the at least one patron scans the code using the patron-controlled device;
wherein scanning the code allows the patron-controlled device to communicate with the platform server;
the platform server further configured to:
a) receive an interaction request from the patron-controlled device,
b) send a notification of the interaction request to the associate device,
c) create a modified interaction request based on the first interaction request,
d) send the modified interaction request to the point of sale system, and
wherein the point of sale system is configured to receive the modified interaction request and to subsequently fulfill the modified interaction request.

2. The system of claim 1, wherein the code comprises at least one of a QR code, a barcode, and an alphanumeric code.

3. The system of claim 1, wherein the associate device comprises a mobile computing device used by a server in a restaurant to take orders.

4. The system of claim 1, wherein the establishment is a restaurant and the location is a table in the restaurant.

5. The system of claim 1, wherein the code is generated by the platform server upon request by the associate device.

6. The system of claim 1, wherein the interaction request and the modified interaction request both comprise an order from the patron to be processed by the point of sale.

7. The system of claim 1, wherein the modified interaction request comprises the same information as the interaction request.

8. A system to facilitate transactions originating from a patron-controlled device, comprising:
a platform server configured to generate a code, wherein the code is associated with a location in an establishment;
wherein the platform server is configured to transmit the code to a code-displaying device, wherein the code-displaying device is placed within the location;
the code-displaying device configured to display the code to at least one patron of the establishment, wherein the patron occupies the location and wherein the at least one patron scans the code using the patron-controlled device;
wherein scanning the code allows the patron-controlled device to communicate with the platform server;
the platform server further configured to:
a) receive an interaction request from the patron-controlled device,
b) send a notification of the interaction request to the associate device,
c) create a modified interaction request based on the first interaction request,
d) send the modified interaction request to the point of sale system, and
wherein the point of sale system is configured to receive the modified interaction request and to subsequently fulfill the modified interaction request.

9. The system of claim 8, wherein the code comprises at least one of a QR code, a barcode, and an alphanumeric code.

10. The system of claim 8, wherein the associate device comprises a mobile computing device used by a server in a restaurant to take orders.

11. The system of claim 8, wherein the establishment is a restaurant and the location is a table in the restaurant.

12. The system of claim 8, wherein the code is generated by the platform server upon request by the associate device.

13. The system of claim 8, wherein the interaction request and the modified interaction request both comprise an order from the patron to be processed by the point of sale.

14. The system of claim 8, wherein the modified interaction request comprises the same information as the interaction request.

15. A method of facilitating transactions originating from a patron-controlled device, comprising:
generating a code at a platform server, wherein the code is associated with a location in an establishment;
transmitting the code to a code-displaying device;
presenting the code to at least one patron of the establishment, wherein the patron occupies the location and wherein the at least one patron scans the code using a patron-controlled device;
wherein scanning the code allows the patron-controlled device to communicate with the platform server;
receiving, at the platform server from the patron-controlled device, an interaction request;
sending, from the platform server to the associate device, a notification of the interaction request;
creating a modified interaction request based on the first interaction request;
sending the modified interaction request to the point of sale system, wherein the point of sale system is configured to receive the modified interaction request and to subsequently fulfill the modified interaction request.

16. The method of claim 15, wherein the code comprises at least one of a QR code, a barcode, and an alphanumeric code.

17. The method of claim 15, wherein the establishment is a restaurant and the location is a table in the restaurant.

18. The method of claim 15, wherein the code is generated by the platform server upon request by the associate device.

19. The method of claim 15, wherein the interaction request and the modified interaction request both comprise an order from the patron to be processed by the point of sale.

20. The method of claim 15, wherein the modified interaction request comprises the same information as the interaction request.
